(19) United States
(12) Patent Application Publication
(10) Pub. No.: US 2011/0239367 A1
(43) Pub. Date: Oct. 6, 2011

(54) HANDLING SYSTEM AND METHOD OF ARRANGING A PERSON SUPPORTED BY A HANDLING SYSTEM

(75) Inventors: Asger Gramkow, Augustenborg (DK); Steffen Sundbaek, Augustenborg (DK)

(73) Assignee: HECARE SYSTEMS APS, Sydals (DK)

(21) Appl. No.: 13/130,772

(22) PCT Filed: Nov. 16, 2009
(86) PCT No.: PCT/DK2009/000237

§ 371 Date: May 24, 2011

(30) Foreign Application Priority Data
Nov. 24, 2008 (DK) PA 2008 01647

(51) Int. Cl. A61G 7/10

(52) U.S. Cl. 5/83.1; 5/81.1 R

(57) ABSTRACT

A handling system for supporting a person, preferably a disabled person, where the handling system facilitates changes of the angular position of the person supported by the support device, the handling system including at least two support connection systems each having at least one support connection, where the invention further relates to a method for arranging a supported person.

### TECHNICAL FIELD

The invention relates to a handling system for supporting a person and a method of arranging a person supported by a handling system.

### BACKGROUND

A handling system is used for supporting persons and particularly disabled and or obese persons.

Typical handling systems comprise a base part provided with wheels supporting a tower with a horizontal arm at the top. The free end of the horizontal arm is connected to a support device such as a harness or a chair supporting and fixating the person during the lifting and/or moving from e.g. a bed to a chair.

Other handling systems may be handling systems mounted in a ceiling.

During the recent years there is a general tendency for increased overweight or obesity in the public, and it is especially relevant and necessary to facilitate tilting of such overweight or obese persons supported by the harness or chair to make the lifting and moving of such persons more pleasant and less straining to these persons' body.

Tilting of persons supported by existing handling systems may be performed manually with activation of a handle or the like, e.g. by a helping person. The handle is substantially directly mechanically connected to the harness or chair, and the helping person has to move a considerably amount of body weight of the supported person to tilt the supported person.

This is disadvantageous since manual tilting may strain such helping persons and complicate the handling of the person supported by the handling system, and even in some cases require more than one helping person to handle the disabled person supported by the handling system. Further, such manual control increases risk of faulty use of the handling system which may result in overturn of the handling system or unnecessary burden to the supported person.

It is also known to tilt a person in a handling system by means of one or more electrical motors or actuators arranged near the harness or in a yoke holding the harness.

This is disadvantageous since electrical cabling from control means to the electrical motors or actuators to control the tilting may be necessary. Likewise, such electrical motors or actuators are disadvantageous when the handling system is used for bathing a person supported by the handling system, since it may increase the risk of subjecting persons to electrical shock, or cause malfunction of the handling system which in both cases increases the demands for electrical shielding of the handling system to prevent such from happening.

Further, the tilting of persons by means of conventional handling systems changes the angular position of the supported person in a manner which in some cases may be disadvantageous, e.g. by lifting the person in one end and simultaneous lowering the person in the other end. This limits the possibilities of adjustment of the person's angular position and may be harder to control.

### BRIEF SUMMARY

The invention provides a handling system without the above mentioned disadvantages, and especially facilitates enhanced adjustment possibilities of the person supported by the handling system.

The invention relates to a handling system for supporting a person, said handling system comprising a frame structure, a support device for supporting said person, and at least two support connection systems each comprising at least one support connection for connection to said frame structure with said support device, where said support connection systems are individually controllable by control means in the frame structure to facilitate displacement between the at least two support connection systems.

Hereby, the support device of the handling system may be tilted in an advantageous and individually controlled manner, since it is possible to control the angular position of the person at one end/area of the support device at a time which may result in a more pleasant and precise control. This is especially advantageous if the supported person is in pain, overweight or obese and/or in other ways disabled. Further, by facilitating changes of the angular position of the supported person at one end/area at the time by controlling/operating one support connection system at a time, it is possible to advantageously adapt the support device (e.g. a harness) to the person's body which may prevent that the support device causes discomfort to parts of the e.g. obese person's body. Likewise, it is hereby possible to enhance the adjustment possibilities of the person.

By the term “individually controllable” is to be understood that each individual controllable support connection system may be controlled independently of other support connection systems of the handling system, e.g. the support connection(s) of one support connection system may be controlled, such as winded or unwinded, in one direction while the support connection(s) of one or more other support connection systems are kept in a fixed position or winded or unwindeded in another direction. Likewise, the support connection systems may be winded or unwinded in the same direction with different speed, thereby both tilting the person and lifting or lowering the person.

In an aspect of the invention said control means comprises individually controllable control systems where said individually controllable control systems each are associated to an individually controllable support connection system to individually control said associated controllable support connection system.

Hereby, it is possible in a simple way to control each of the support connection systems individually.

By the term “individual controllable control systems” is to be understood that each control system may be operated independently of other control systems to control the associated support connection system.

In an aspect of the invention said support device is via support means connected to said frame structure.

Hereby, an enhanced steering of the support connections and a more stable handling system is achieved.

In an aspect of the invention said support means is fixed at least in the horizontal plane to the frame structure.

Hereby, a more simple control of the tilting of the supported person is achieved since individual vertical displacement, e.g. angular displacement of the support means is not an active parameter of the control of the tilting of the supported person. Further, by avoiding individually vertically displacement of the support means, it is possible to avoid changes in the distance between the support connections that hold/support the support device during the tilting. Such changes in the distance between the support connections may be unpleasant to the supported person and may result in ergonomic undesired positions of the person.

In an aspect of the invention, said support means is rotatable connected to said frame structure to be at least partly rotatable in the horizontal plane.

Hereby it is achieved that the supported person can be rotated in the horizontal plane in relation to the frame structure hereby facilitating that the whole handling system does not have to be rotated to rotate the supported person.

The support means may be rotatable in the horizontal plane into it reaches a limitation, e.g. a rotation between 0-180° each way such as from 0-110° to avoid damages or wear on the support connections which is twisted when rotating the support means.

In an aspect of the invention each of said support connection systems is individually lockable by locking means.

Hereby, it is possible to only operate/displace one support connection system at a time which is simple and advantageous when tilting obese persons, since the control may be performed more precisely and with lesser movements of the person at a time during the tilting.

In a further aspect of the invention, said handling system comprises one or more support connection guides guiding one or more of said support connections.

Hereby, it is possible to avoid that the support connections get entangled during operation. Further, precise positioning of the support connection systems is achieved.

In an aspect of the invention, said handling system comprises a bottom part with a guiding part being vertically fixed, and a lifting arm comprising a horizontal part including a free lifting end and vertical part including a guided end being guided inside said guiding part to allow said lifting arm to be at least vertically adjustable, where said support connection systems are arranged inside said bottom part and said lifting arm, e.g. as part of modular support connection systems.

Hereby, an advantageous mobile handling system is achieved. Further, if the handling system comprises modular support connection systems it is possible to adapt the handling system at any time with the number of support connection systems desired.

In a further aspect of the invention, said control means is arranged in said bottom part.

Hereby, the control means is arranged remote to the support means and is at the same time movable together with the handling system. Further, the centre of mass of the handling system may be lowered which gives a more stable handling system.

The invention further relates to a method of arranging a person supported by a handling system, said method comprising the steps of supporting said person in a support device of said handling system, arranging said support device by individually controlling at least two support connection systems connecting said support device and a frame structure of said handling system in order to at least changing the angular position of the person supported by the support device.

Hereby, the advantages mentioned above are achieved.

In an aspect of the method according to the invention, at least one of said support connection systems is displaced relative to at least one other of said support connection systems which is not displaced, while the at least one support connection system which is not displaced, is kept in a locked position.

Hereby, a precise, safe and user friendly adjustment of the tilting of the person is achieved. Likewise, it is achieved that only one end/part of the support device may be moved to tilt the person which causes less strain on the person's body which is advantageous, especially if the supported person is in pain and/or is obese.

In an aspect of the method according to the invention, at least one first support connection system and at least one other support connection system are simultaneously displaced relative to each other in opposite directions.

Hereby, a fast tilting of the supported person is achieved, which is advantageous in some cases to avoid the person being impatient if the person has to be exposed to a relatively large change of the angular position. The impatience may result in the supported person moving which may result in imbalance of the person and even the handling system, especially if the supported person is obese.

In an aspect of the method according to the invention, said individually controllable support connection systems are controlled simultaneously in the same direction to lift or lower said supported person.

Hereby, lifting and lowering the person from/onto a bed, a chair or the like is enabled, and at the same time the angular position of the supported person may likewise be alterable if the speed of the support connection systems is different. Likewise it is advantageous since the person may be lifted, lowered and e.g. also tilted by the same control means.

In an aspect of the invention, a handling system is used as a mobile system or as a ceiling mounted handling system.

In an aspect of the invention, a is used in a mobile handling system or in a ceiling mounted handling system.

### BRIEF DESCRIPTION OF THE DRAWINGS

The invention will be described in the following with reference to the figures in which

FIG. 1 shows an example of a common handling system,

FIG. 2 shows a part of the handling system according to the invention,

FIGS. 3a-4b show a schematic view of different embodiments of the control means of the handling system,

FIGS. 4a-4b show the individual support connection systems and control means seen from another view,

FIG. 5 shows the support connection systems arranged side by side in a handling system according to the invention,

FIG. 6 shows the support means comprising four support members,

FIG. 7 shows an embodiment of a movable handling system according to the invention seen in perspective,

FIG. 8 shows path of the support connection systems 6a, 6b in the movable handling system in FIG. 7,

FIG. 9 shows an example of the arrangement of the control means in the movable handling system shown in FIGS. 7 and 8,

FIG. 10 shows an embodiment of a handling system according to an embodiment of the invention mounted in a ceiling,

FIG. 11 shows an embodiment of a control panel for control of the handling system according to the invention,

FIG. 12 shows an embodiment where the support means is rotatable arranged, and

FIG. 13 shows an embodiment where the support means is a part of a horizontal part of a lifting arm.

### DETAILED DESCRIPTION

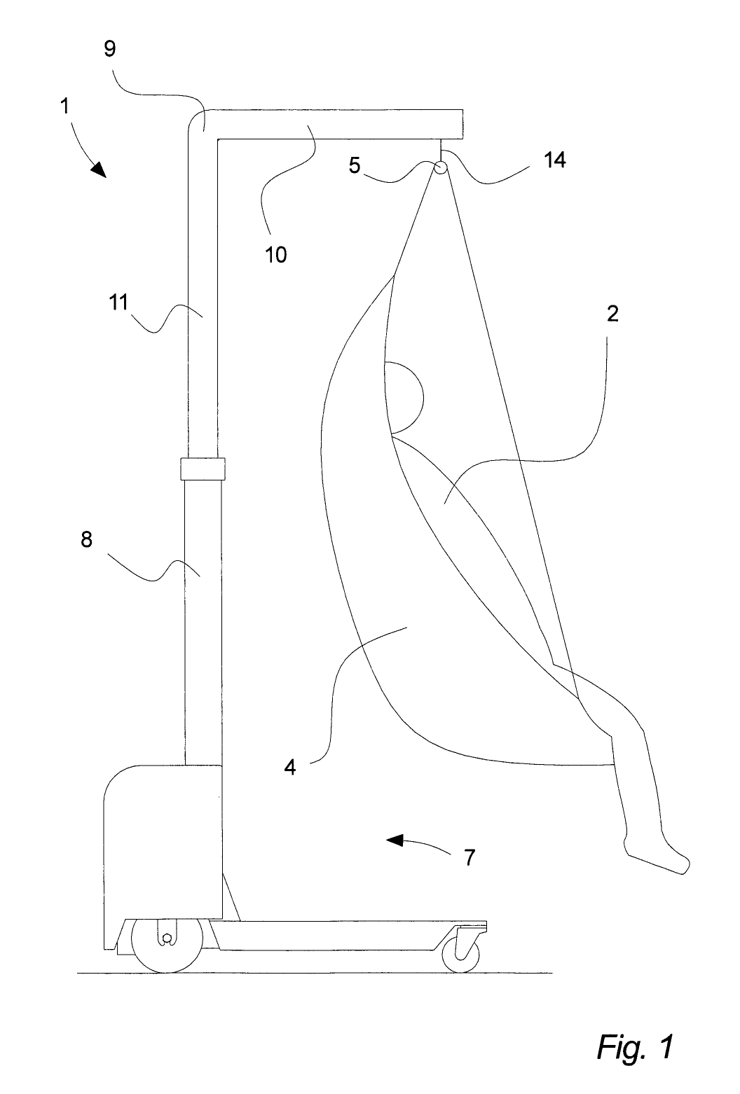

FIG. 1 shows an example of a handling system 1 for supporting a person 2. The handling system comprises a bottom part 7 provided with wheels and comprising a guiding part 8, and a lifting arm 9 with a horizontal part 10 and a vertical part 11. The handling system 1 in FIG. 1 further comprises a support device 4 which fixates and supports the person 2, and a support connection 14 which is connected to the support device 4. The handling system further comprises stabilizing means 5 for connecting the support connection 14 and the support device 4.

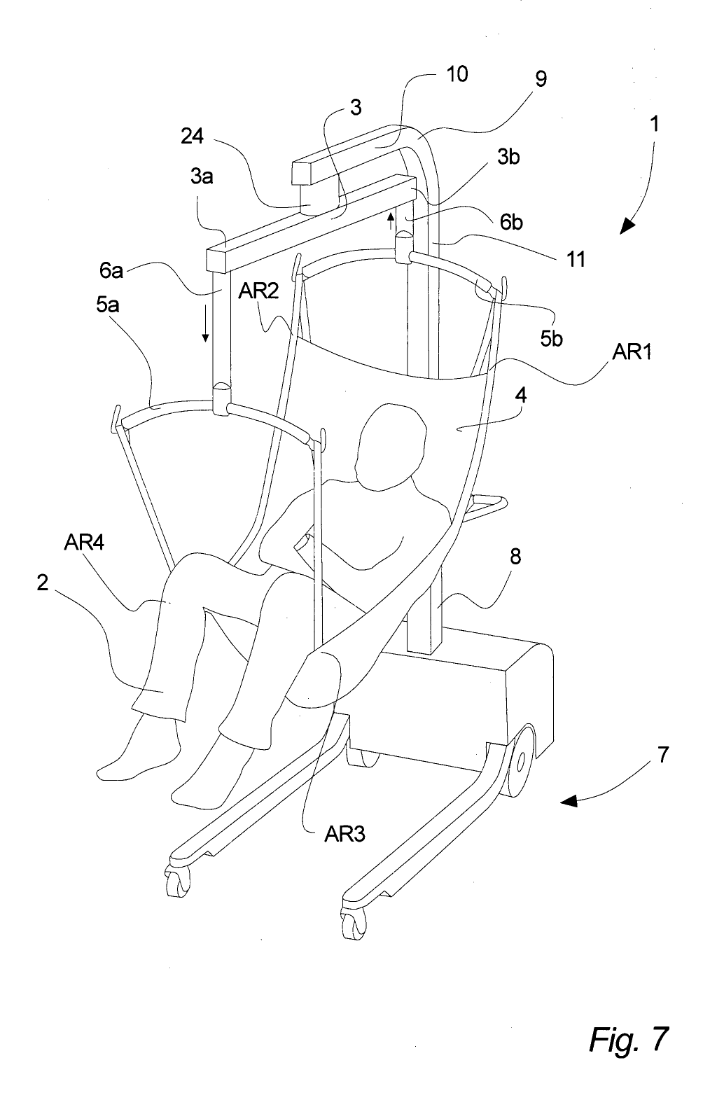

It is in general understood that the handling system 1 according to the invention preferably comprises a frame structure. The frame structure may e.g. be the bottom part 7 (e.g. such as the bottom part shown in FIG. 7) comprising the lifting arm 9, it may be a part arranged in a ceiling (e.g. such as the frame structure 20 for the handling system arranged in a ceiling shown in FIG. 10) or the like.

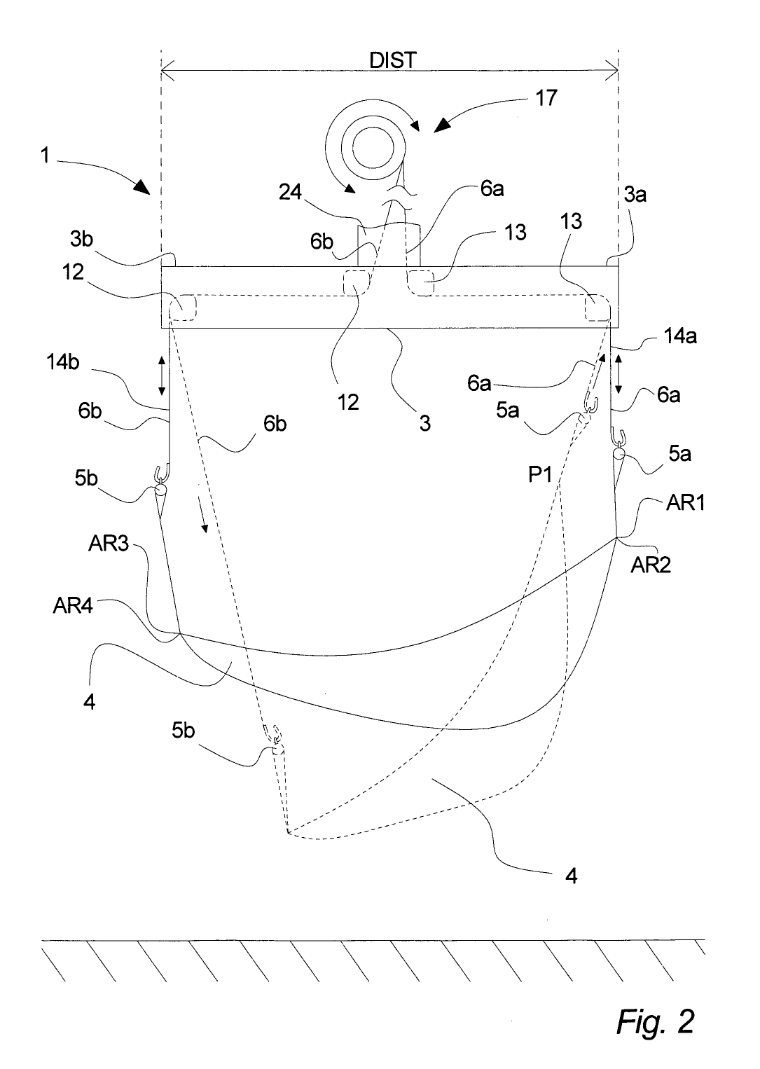

FIG. 2 shows a part of the handling system 1 according to the invention with support means 3. The support means 3 in FIG. 2 comprises support members 3a, 3b, such as support arms. The support means 3 may, however, in other embodiments be a plate, a frame or the like, and the support members 3a, 3b may be an area of such frames or plates. Individually controllable support connection systems 6a, 6b, also referred to as support connection systems 6a, 6b in the following, extends through or passes out through/from the support members 3a, 3b. It is preferred that the support connection systems 6a, 6b are guided inside the support means 3 (and the handling system 1 generally), but it is understood that the support connection systems 6a, 6b may also at least partly be guided on one or more outside surfaces of the support means 3 and/or handling system 1.

It is furthermore preferred that the support means 3 are fixed at least in the horizontal plane to the frame structure to avoid that the support means 3 are individually vertically displaceable. It is understood that the support means 3 may in an embodiment, while being fixed in the horizontal plane to the frame structure, be individually horizontally rotatable to facilitate rotation of the person 2 as described later on.

Each of the individually controllable support connection systems 6a, 6b comprises one or more support connections 14a, 14b which are substantially directly or indirectly (e.g. through stabilizing means which is described later) connected to two or preferably more points/areas AR1, AR2, AR3, AR3 on a support device 4 such as a harness or a chair which fixates and supports a person 2 (not shown in FIG. 2).

The support connections of the support connection systems 6a, 6b are preferably split up in the support part 3 in different directions, e.g. by extending the support connections 14a, 14b of the support connection systems 6a, 6b through the support members 3a, 3b as illustrated in FIG. 2, to support the support device 4 at two or more different points/areas AR1, AR2, AR3, AR3, thereby facilitating a more stable support of the person 2. It is preferred that the support members 3a, 3b are arranged remote with a certain distance DIST between the support members to facilitate a further stabilizing function, e.g. to prevent that the support connections 14a, 14b of the support connection systems are twisted and thereby at least partly unintentionally rotates the person 2.

The individually controllable support connection systems 6a, 6b are individually displaceable in relation to each other to facilitate tilting of the support device 4 and hereby the supported person 2, so the person 2 may be arranged in a sitting position, a lying position or a position between a sitting and lying position.

By the term “tilt” or “tilting” is to be understood a change of the angular position of the support device 4 and hereby also the person 2.

The tilting of the person 2 is achieved by displacing one or both the support connections 14a, 14b of the individual support connection systems 6a, 6b in relation to the other. E.g. the support connection of the system 6b may be displaced by winding or unwinding the support connection of the system 6b, while the support connection of the system 6a is kept in a locked position or vice versa. The locking of a support connection system may be performed by a mechanical brake, by the drive means or other means known to a person skilled in the art. Alternatively, both support connections 14, 14 b of the connection systems 6a, 6b are displaced simultaneously but in opposite directions to facilitate a faster tilting of the support device 4.

By winding or unwinding the support connection systems simultaneous in the same direction, e.g. without displacing the support connections of the systems 6a, 6b in relation to each other, the person 2 may be lifted or lowered.

The support means 3 preferably comprises an extending part 24 which connects the support means 3 to the rest of the handling system 1. However, in other embodiments of the invention, the support means 3 may be connected to the rest of the handling system 1 substantially directly, it may be an integrated part of the handling system 1 e.g. incorporated in a casing or the like in a handling system mounted in a ceiling, in a lifting arm or the like.

In an embodiment of the invention, each individual controllable support connection system comprises one support connection, but it is understood that in other embodiments of the invention each individually controllable support connection system may comprise two, three or even more support connections which will be described later on.

Even though the handling system 1 is described in the following with two individually controllable support connection systems 6a, 6b which is preferred, the handling system 1 may in other embodiments of the invention comprise more than two individual support connection systems such as three four or five individual support connection systems. This may facilitate an even more controllable handling of tilting the person 2 since more support connection systems may be connected to the support device 4 and facilitate tilting of the person 2 in more directions.

The handling system 1 in FIG. 2 comprises stabilizing means 5a, 5b such as beams, a frame or the like. Such stabilizing means 5a, 5b are advantageous when the support means 3 comprises only two areas/support members 3a, 3b from which the support connections 14a, 14b of the support connection systems 6a, 6b extend, to facilitate a more controlled support of the person 2 supported by the support device 4. If the support means 3 comprises more than two support members such as three, four or more support members as described later on, and at least one of the individually controllable support connections systems 6a, 6b comprises more than one support connection such as e.g. two support connections, the stabilizing means 5a, 5b may be at least partly spared which may be advantageous in relation to moving the handling system (if possible) and which may be cost efficient.

The support connections 14a, 14b of the support connection systems 6a, 6b are guided by support connection guides 12, 13. These support connection guides 12, 13 may be idling pulleys, it may be fixed support connection guides with low friction surfaces over which the support connection(s) may slide, or the like. Such fixed support connection guides may be made of or covered with a polytetrafluoroethylene material (a Teflon material), they may be made of silicon, suitable polymer materials or other suitable materials or compositions of materials known to a person skilled in the art.

The support connections 14a, 14b are preferably continuous belts, but it may also be cords, wires or the like. The support connections 14a, 14b may also be chains, whereby at least some of the support connection guides 12, 13 may be toothed wheels.

The handling system 1 may comprise displacement limiting means (not illustrated) which may determine the displacement between the support connection systems 6a, 6b and prevent a displacement above a certain amount, to ensure that the person 2 may not be tilted into unwanted/unintended outer positions, e.g. positions where the person is leaned too much back towards the rear and/or too much forward.

This may e.g. be achieved by comparing how much one individually controllable support connection system is displaced, e.g. winded/unwinded, compared to the other(s) by measuring the position of the drive means and/or reel(s). Alternatively or as a supplement the displacement limiting may be obtained by measuring the length of one unwinded support connection system compared to another support connection system, e.g. by detecting markings on the support connection systems, or directly by detecting movement of the support connection systems. It is understood that any suitable displacement limiting means known to a person skilled in the art may be relevant for limiting the displacement of the support connection systems. The handling system 1 may likewise comprise indication means such as light emitting means, e.g. one or more LEDs (not illustrated) or indications in a display, which e.g. may be arranged at one or more control panels, for indicating when no further tilting and/or lifting or lowering of the supported person (2) is possible/permitted.

The handling system 1 further comprises control means 17 which comprises drive means such as electrical motors 25, 25a, 25b as described later on, adapted for winding and unwinding the support connection systems 6a, 6b individually. The control means 17 is preferably arranged remote to the support device 4, the support means 3, and optional stabilizing means 5a, 5b, and are preferably the same control means 17 which is used for lifting and lowering the person 2 in the support device 4 as described above. Thereby, control means may be spared and the handling system 1 is more resistant to water which is advantageous if the person 2 supported by the handling system is bathed.

It is understood that the control means 17 may be arranged in any suitable position in the handling system 1, e.g. in a bottom part of the handling system (1), near the ceiling or the like as described later on.

The control means 17 controls the winding and unwinding of the support connection system 6a comprising support connection(s) 14a and the winding and unwinding of the connection system 6b comprising the support connection(s) 14b.

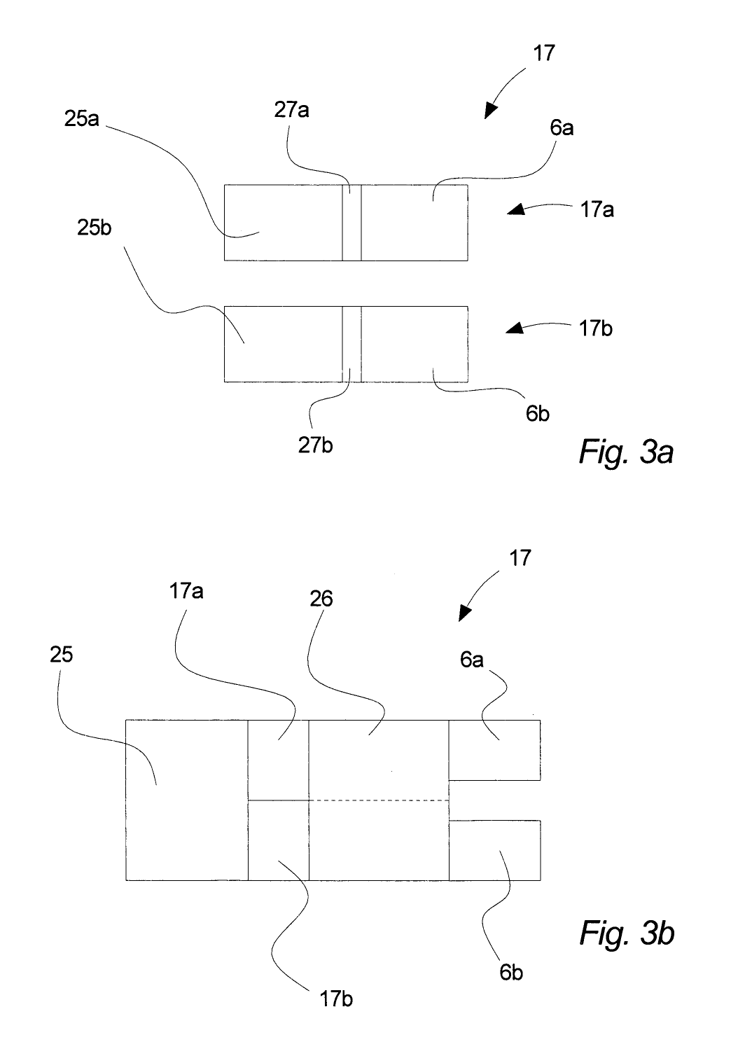

FIGS. 3a and 3b show different embodiments of the control means 17. As illustrated in FIG. 3a the control means 17 may comprise individual control systems 17a, 17b which each may comprise drive means 25a, 25b such as an electrical motor. Each individual control system 17a, 17b is associated to a support connection system 6a, 6b, preferably through gearing means 27a, 27b, for individual control of the associated support connection system. E.g. a first individual control system 17a comprising drive means 25a may be associated to the support connection system 6a, and a second individual control system 17b comprising drive means 25b may be associated to the support connection system 6b as illustrated in FIG. 3a.

Alternatively as illustrated in FIG. 3b, the control means 17 comprises individual control systems 17a, 17b and drive means 25 such as an electrical motor connected to gearing means 26, where the gearing means 26 facilitates individual control of the support connection systems 6a, 6b by means of individually controlling the control systems 17a, 17b.

It is understood that in other embodiments of the invention support connection systems may be controlled by a combination of gearing means 26 facilitating individual control of support connection systems and more than one motor, which may be especially advantageous if the handling system 1 comprises more than two individual control systems.

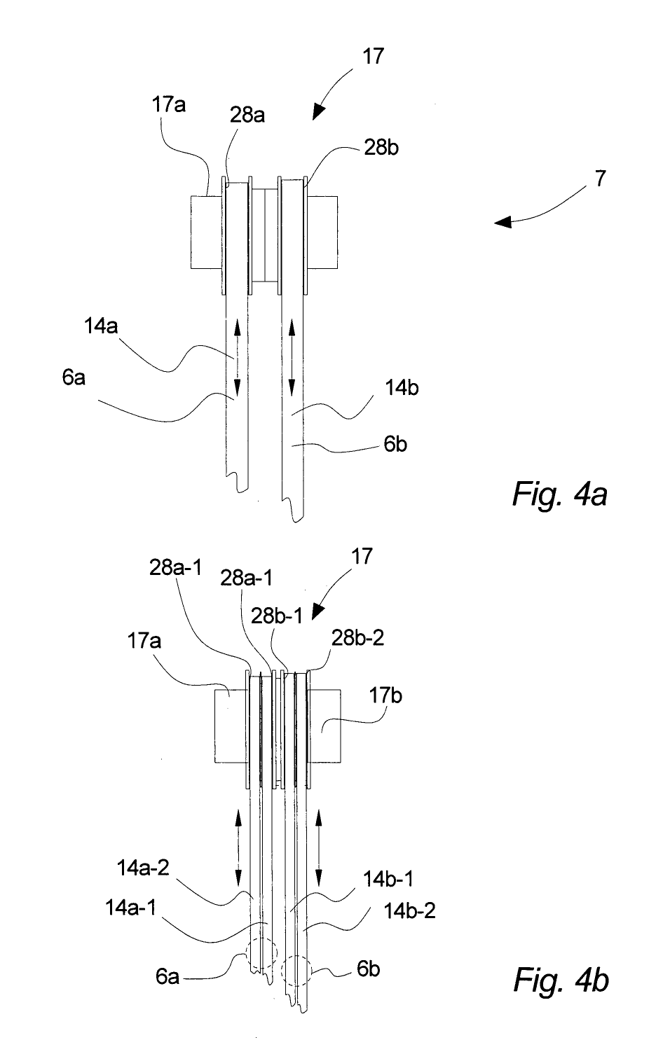

FIGS. 4a and 4b show the individual support connection systems 6a, 6b from another view. The support connections 14a, 14b, 14a-1, 14a-2, 14b-1, 14b-2 of the individual support connection systems 6a, 6b are preferably windable and unwindable on a reel 28a, 28b, 28a-1, 28a-2, 28b-1, 28b-2.

The support connection systems 6a, 6b in FIG. 4a each comprises one support connection 14a, 14b which are connected to the support device 4 (not shown in FIG. 4a or 4b).

The support connection systems 6a, 6b in FIG. 4b each comprises two support connections, where the support connection system 6a comprises the support connections 14a-1 and 14a-2, and the support connection system 6b comprises the support connections 14b-1 and 14b-2. This may be advantageous since it is thereby possible to spare stabilizing means 5a and/or 5b.

As indicated by arrows in FIGS. 4a and 4b the support connection systems 6a, 6b are individually controllable by individually controlling the individually controllable control systems 17a, 17b of the control means 17.

FIG. 5 shows the support connection systems arranged side by side in the handling system. It is preferred that the support connections of the support connection systems 6a, 6b are arranged side by side in the handling system 1 where it is appropriate, e.g. where the support connection systems 6a, 6b follows the same path. Hereby, it is possible to use a common shaft 18 for support connection guides 12, 13 associated to different support connection systems 6a, 6b as illustrated in FIG. 5. Alternatively the support connection systems and the associated support connection guides may be arranged above each other, e.g. to save space.

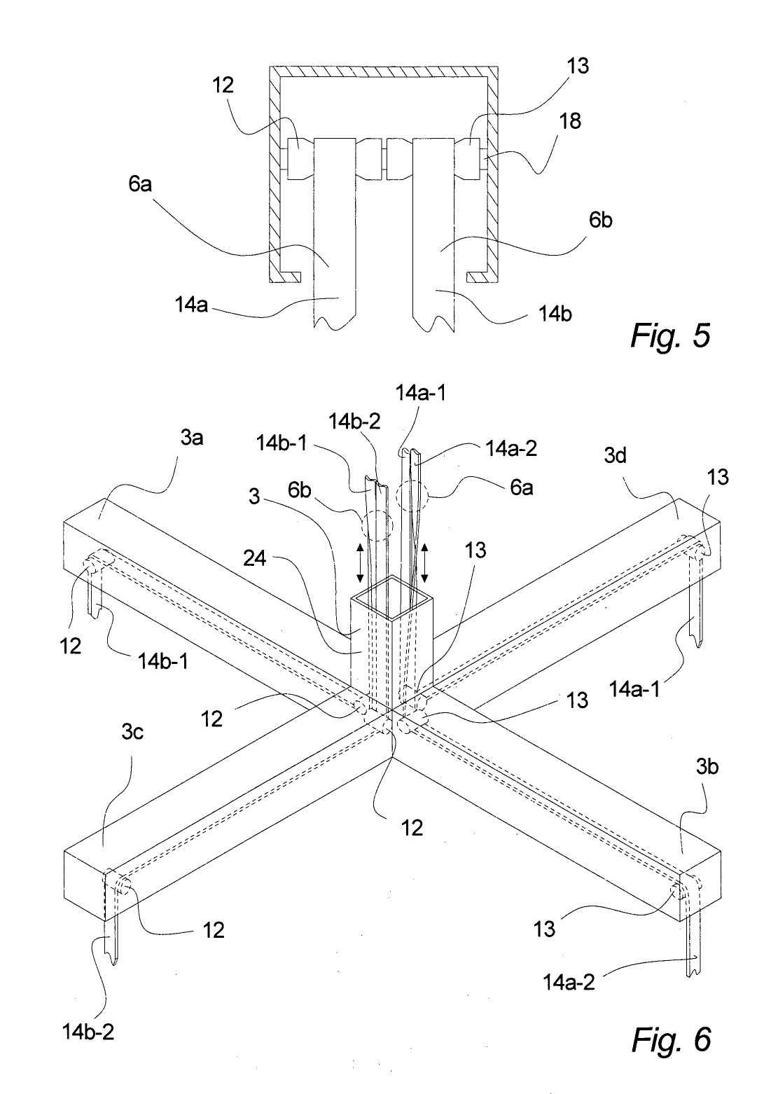

FIG. 6 shows the support means 3 comprising four support members 3a, 3b, 3c, 3d, in FIG. 6 illustrated as support arms. The support members 3a, 3c are associated with a first individually controllable support connection system 6b comprising two support connections, the support connections 14b-1 and 14b-2 respectively, and the support members 3b, 3d are associated with a second support connection system 6a comprising two support connection systems, the support connections 14a-1 and 14a-2 respectively. The support connections may hereby be substantially directly connected to areas (e.g. AR1-AR4—not shown in FIG. 6, see FIG. 7) of the support device 4. As an example, the support connection 14b-1 may be connected substantially directly to a first area AR4 of the support device 4, support connection 14b-2 may be substantially directly connected to an area AR3 of the support device 4, support connection 14a-1 may be substantially directly connected to area AR2 of the support device 4, and support connection 14b-2 may be substantially directly connected to area AR3 of the support device 4. By individually winding or unwinding the support connection systems 6a and 6b, it is hereby possible to tilt a person 2 supported by support device 4 without the stabilizing means 5a, 5b as described above, and still achieve a stabilizing function. By winding or unwinding the support connection systems 6a and 6b simultaneously in the same direction, it is possible to lift or lower the person 2 in the support device 4 as described above.

FIG. 7 shows an embodiment of a movable handling system 1 facilitating lifting and moving a person 2 e.g. from a bed to a chair. The person 2 is supported by a support device 4 such as a harness or a chair. The support device 4 is connected to individually controllable support connection systems 6a, 6b which is extending through the support members 3a, 3b of the support means 3.

The individual support connections of the support connection systems 6a, 6b are individually windable and unwindable by the control means 17 (not illustrated in FIG. 7) to facilitate a displacement between the support connection systems 6a, 6b to tilt the person 2. By winding or unwinding the support connection systems 6a, 6b together in the same direction, the person 2 can be lifted or lowered without performing tilting of the person 2.

The handling system 1 in FIG. 7 comprises a bottom part 7 with a guiding part 8 which is vertically fixed, and a lifting arm 9 comprising a horizontal part 10 with a free end and a vertical part 11 with a guided end which is guided inside the guiding part 8. Hereby, the lifting arm 9 is at least vertically displaceable.

In an embodiment of the invention, the handling system 1 comprises modular support connection systems (6a, 6b) to facilitate that the desired/needed number of support connection systems is available.

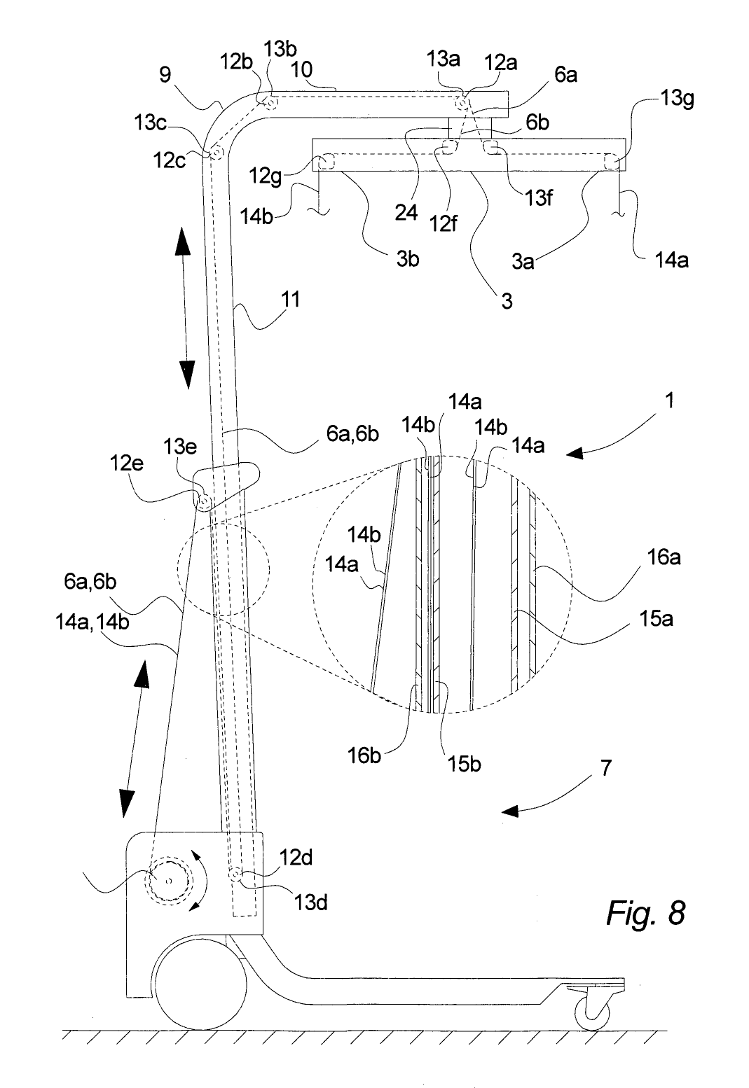

FIG. 8 shows path of the support connection systems 6a, 6b in the movable handling system 1 shown in FIG. 7. The support connection systems 6a, 6b each comprises one or more support connections 14a, 14b which are guided by support connection guides 12a-12g and 13a-13g. It is understood that the support connection guides 12a-12g guide the support connection system 6a, and the support connection guides 13a-13e guide support connection system 6b.

Front support connection guides 12a and 13a are positioned inside the free end of the lifting arm 3, the corner support connection guides 12b, 12c, 13b, 13c are positioned substantially in the bend of the lifting arm 3 and the bottom support connection guides 12d, 13d are positioned in the guided end of the lifting arm 3. The top support connection guides 12e, 13e are positioned at the top of the section of the bottom part guiding the lift arm 3. The support means 3 comprises support connection guides 12f, 12g, 13f, 13g for guiding the support connections in the support members 3a, 3b of the support means 3.

The vertical part 11 of the lifting arm 9 is established by walls including a front and rear wall 15a, 15b as illustrated. The walls are surrounded by inner walls of the vertical guiding part 8 including a front and rear wall 16a, 16b. The rear walls 15b, 16b are separated by a minor space allowing the support connection systems 6a, 6b to be moved inside the space. Further, the support connection systems 6a, 6b are guided and moved inside the vertical part 11 of the lifting arm 9 (e.g. between the walls 15a, 15b).

The support connection 14a, 14b are moved through an opening in the side wall or bottom of the vertical part 11 and enters the above mentioned minor space before reaching the top support connection guides 12e, 13e through an opening in the rear wall 16b. The top support connection guides 12e, 13e direct the support connections 14a, 14b toward control means 17, e.g. comprising the individual controllable control systems 17a, 17b as described earlier, fixed to the bottom part 7.

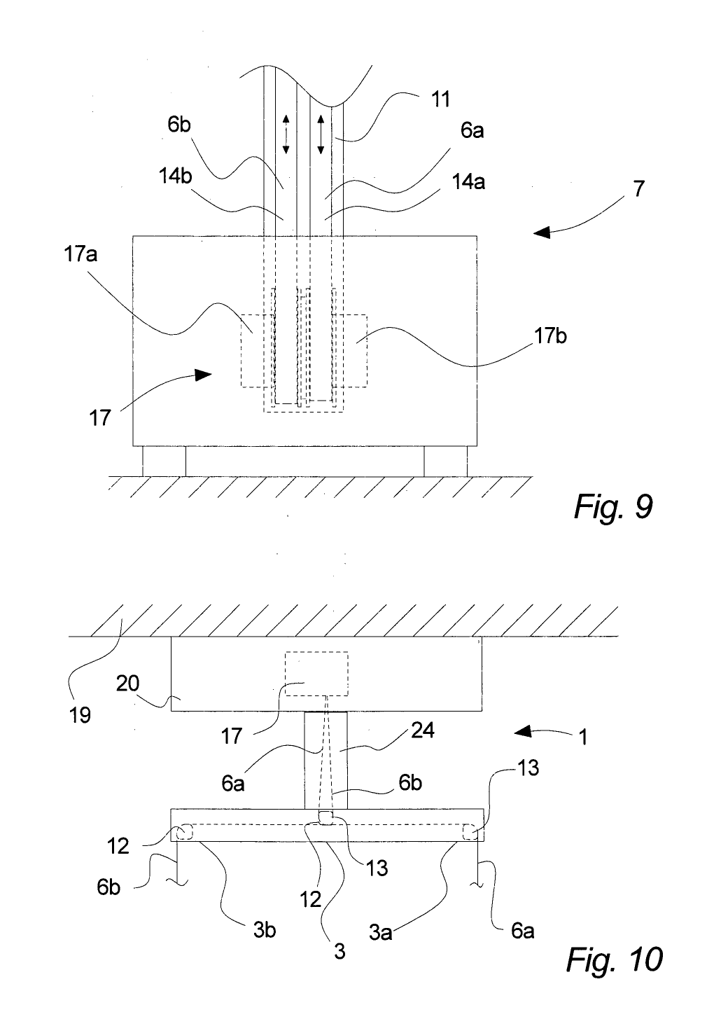

FIG. 9 shows an example of the arrangement of the control means 17 covered by a casing of the bottom part 7 of the handling system 1 as described in relation to FIGS. 7 and 8.

FIG. 10 shows an embodiment of the handling system 1 mounted in a ceiling 19. The control means 17 is preferably arranged in the frame structure 20 remote to the support means 3, the support device 4 (not shown in FIG. 8) and any stabilizing means 5a,5b (not shown in FIG. 8). The handling system 1 arranged in the ceiling may be fixed at one area at the ceiling 19 or it may be connected to a rail system (not illustrated) mounted in the ceiling 19 to facilitate that the handling system 1 arranged in the ceiling 19 may be horizontally movable.

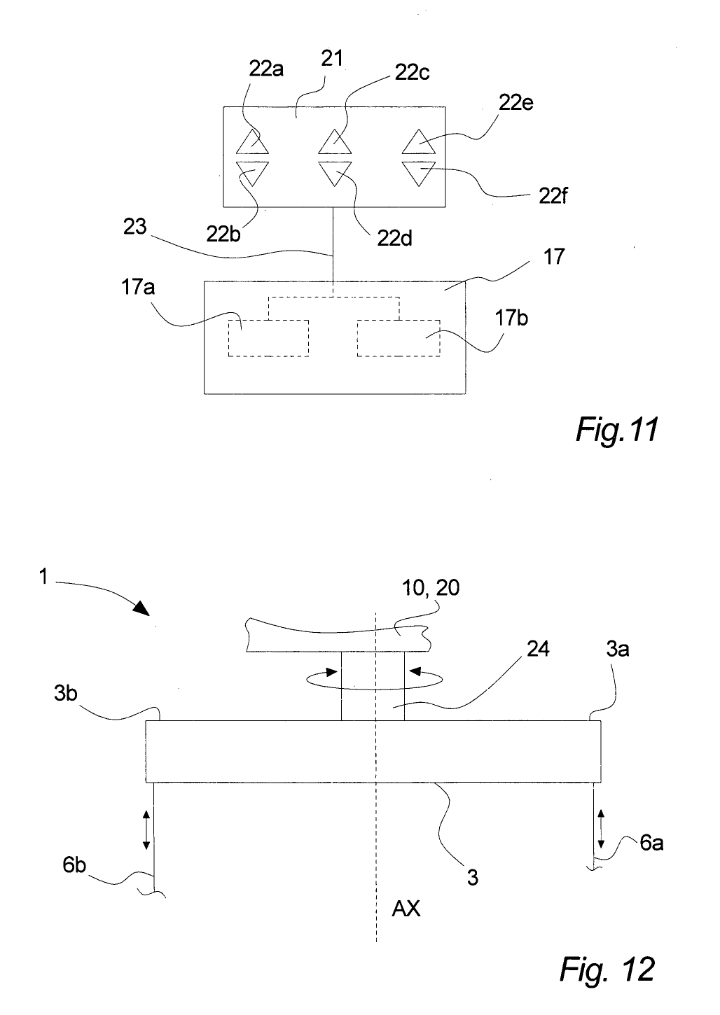

FIG. 11 shows an embodiment of a control panel 21 for control of the handling system 1. The handling system 1 may comprise one or more control panels 21 such as control panel(s) 21 arranged at the handling system (1) and/or wired or wireless remote control(s) 21. The control panel 21 comprises control buttons 22a-f such as buttons, one or more touch screens (not illustrated) or the like which facilitates control of the tilting of the person 2 and the lifting and lowering of the person 2. E.g. may control button 22a facilitate lifting of the person 2, control button 22b may facilitate lowering the person 2, control buttons 22c, 22d may facilitate lifting and lowering the front of the support device 4 (not illustrated in FIG. 9) individually, and control buttons 22e, 22f may facilitate lifting and lowering the back of the support device 2 individually. Hereby, it is possible to perform a precise tilting of the person 2, since the support connection systems may be controlled individually.

It is understood that the control panel(s) 21 may comprise further control buttons, e.g. for controlling a tilting of the person 2 by displacing the support connection systems in different directions simultaneously as described above to perform a faster tilting.

The control panel 21 may also comprise information means (not illustrated) for informing a user of the handling system 1 that the handling system has reached a limit for tilting a person, lifting or lowering a person or the like.

FIG. 12 shows a preferred embodiment of the invention with the support means 3 being rotatable arranged. The support means 3 is rotatable arranged at the horizontal part 10 of a lifting arm 9, or at/in the frame structure 20 if the handling system 1 is mounted in a ceiling 19 as described above. This facilitates that the person 2 supported by the support device 4 (not shown in FIG. 12) may be substantially horizontally rotated around a vertical axis AX. The rotation of the support means 3 may be performed manually, and results in an at least partly twisting of the support connections of the support connection systems 6a, 6b. The support means 3 may in an embodiment be electrically lockable (e.g. by means arranged at the control panel 21) and/or manually lockable to prevent unintentional rotation of the support means 3 and thereby the person 2. The extending part 24 of the support means 3 may be connected through bearings, e.g. such as ring bearings (not shown) to the rest of the handling system 1 to facilitate a more frictionless and easy horizontal rotation of the support means 3. It is of cause understood that the extending part (and hereby the support means (3) may in other embodiments not be rotatable arranged.

A limitation of the rotation of the support means (3), e.g. a mechanical limitation, may be applied to avoid damages or wear on the support connections which are twisted when rotating the support means. E.g. the limitation may prevent a critical twisting of the support connections by only allowing a rotation between 0° and 180° each way, between 0° and 120° each way, between 0° and 90° each way or the like.

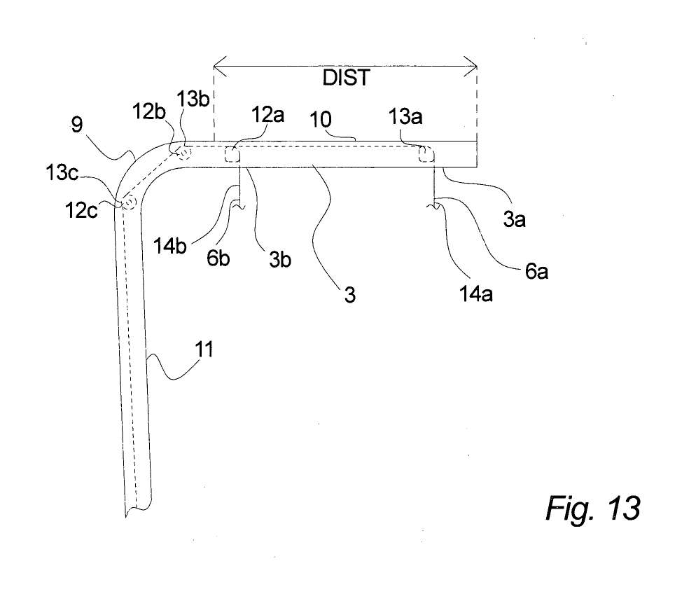

FIG. 13 shows an embodiment of the invention where the support means 3 and the support members 3a, 3b are a part of the horizontal part 10 of the lifting arm 9. The support means 3 and the support members are incorporated in the horizontal part 10, to facilitate the function of the support means 3 and the support members 3a, 3b or even more support members. The support members 3a, 3b are displaced by a distance DIST between the support members to facilitate a stabilizing function as described above.

It should be understood that the invention is not limited to the particular examples described above but may be designed and altered in a multitude of varieties within the scope of the invention as claimed.

1.-15. (canceled)

16. Handling system for supporting a person, said handling system comprising:
a frame structure,
a support device for supporting said person, and
at least two support connection systems each comprising at least one support connection for connection to said frame structure with said support device,
where said support connection systems are individually controllable by a control arrangement in the frame structure to facilitate displacement between the at least two support connection systems.

17. Handling system according to claim 16 wherein said control arrangement comprises individually controllable control systems where said individually controllable control systems each are associated to an individually controllable support connection system, to individually control said associated controllable support connection system.

18. Handling system according to claim 16 wherein said support device is via a support arrangement connected to said frame structure.

19. Handling system according to claim 18 wherein said support arrangement is fixed at least in the horizontal plane to the frame structure.

20. Handling system according to claim 18 wherein said support arrangement is rotatable connected to said frame structure to be at least partly rotatable in the horizontal plane.

21. Handling system according to claim 16 wherein each of said support connection systems is individually lockable by a locking arrangement.

22. Handling system according to claim 16, wherein said handling system comprises one or more support connection guides guiding one or more of said support connections.

23. Handling system according to claim 16, wherein the frame structure of said handling system comprises a bottom part with a guiding part being vertically fixed, and a lifting arm comprising a horizontal part including a free lifting end and a vertical part including a guided end being guided inside said guiding part to allow said lifting arm to be at least vertically adjustable, where said support connection systems are arranged inside said bottom part and said lifting arm, e.g. as part of modular support connection systems.

24. Handling system according to claim 16, wherein said control arrangement is arranged in said bottom part.

25. Method of arranging a person supported by a handling system, said method comprising the steps of:
supporting said person in a support device of said handling system,
arranging said support device by individually controlling at least two support connection systems connecting said support device and a frame structure of said handling system in order to at least changing the angular position of the person supported by the support device.

26. Method according to claim 25, wherein at least one of said support connection systems is displaced relative to at least one other of said support connection systems which is not displaced, while the at least one support connection system which is not displaced, is kept in a locked position.

27. Method according to claim 25, wherein at least one first support connection system, and at least one other support connection system are simultaneously displaced relative to each other in opposite directions.

28. Method according to claim 25, wherein said individually controllable support connection systems are controlled simultaneously in the same direction to lift or lower said supported person.

29. Handling system according to claim 16, wherein the system is configured as a mobile system or as a ceiling mounted handling system.

30. Method according claim 25, further comprising arranging said person in a mobile handling system or in a ceiling mounted handling system.
